(19) United States
(12) Patent Application Publication
(10) Pub. No.: US 2025/0245869 A1
(43) Pub. Date: Jul. 31, 2025

(54) SYSTEM AND METHOD TO GENERATING VIDEO BY TEXT

(71) Applicant: Idomoo LTD, Raanana (IL)

(72) Inventors: Danny KALISH, Raanana (IL); Dan SHAMIR, Raanana (IL)

(21) Appl. No.: 18/964,125

(22) Filed: Nov. 29, 2024

Related U.S. Application Data
(60) Provisional application No. 63/603,250, filed on Nov. 28, 2023.

(51) Int. Cl. G06T 11/00; G06F 40/279; G06N 20/00

(52) U.S. Cl. CPC G06T 11/00; G06F 40/279; G06N 20/00

(57) ABSTRACT

A method for generating customized AI model for generating video, implemented by one or more processors operatively coupled to a non-transitory computer readable storage device, on which are stored modules of instruction code that when executed cause the one or more processors to perform the method including the steps of identifying from user text of new category for generating video by analyzing context, comparing to known categories of video by using AI model to identify known or new category; generating in real time personal/customized AI model for new category by learning subject by third party AI large language acting as an expert for generating new AI model for new category trained by data of different types of videos and use case, for different subjects and video structure; generating in real time personal/customized video by applying the generated AI model of the new category using the user original prompt.

### BACKGROUND

### Technical Field

The present invention relates generally to automatic generation of video to by text.

### SUMMARY

The present invention discloses a method for generating (promotion)/video, said method comprising the steps of:
Selecting video type: promotion, education, informative, entrainment
Receiving text message of user describing the requested video;
Applying generative AI model for generating promotion/marketing concept or educational, informative, entrainment;
Applying generative AI model for determining video style, wherein the style include emotion type, design format, length, limited by Personal style; Design limitation Brand guidance
Applying generative AI model for creating layout structure of video scenes, each layout structure of video scene is designed to match promotional concept, video style;
Applying generative AI model for creating text script based on the generated marketing concept, style and format for video using the text messages, wherein the script is comprised of scenes, each scene is designed to match layout structure of video scenes
Wherein the video is comprised of scenes, each scene has motion layout format including definitions of type of objects appearing, layout of objects, order of displaying objects.

The present invention discloses a method for generating video, implemented by one or more processors operatively coupled to a non-transitory computer readable storage device, on which are stored modules of instruction code that when executed cause the one or more processors to perform said method comprising the steps of:
receive user instructions by text or voice using natural language.
analyzing user instructions, identifying technical requirements (where to display, time format), required, style, context and/or content, number, type and properties of content objects, layout of video frames, order—sequence of disapplying content, functionality of objects, optionally object customization option;
selecting video template based analysed instructions or generating new video template
exploring and aggregating content of text, image or video multimedia based on identified requirements;
creating scenes, optionally generating new content using inter or external graphic multimedia tools
   Generating new video by implementing selected or new video template using aggregating content wherein the generated video complies with all analyzed requirements;
According to some embodiments the method according to the present invention further comprising the steps of:
Generating multiple videos which implement selected or new video template using aggregating content wherein the generated video complies with all analyzed requirements, wherein each video may use different template or using different content or properties of objects;
Enabling user select one of the videos, saving users history choice
Learning personalized user preferences;
Ai learning plurality of user's choice, training video editing rules

The present invention provides a method for generating customized AI model for generating video, implemented by one or more processors operatively coupled to a non-transitory computer readable storage device, on which are stored modules of instruction code that when executed cause the one or more processors to perform said method comprising the steps of:
Identifying from user text of new category for generating video by analyzing context, comparing to known categories of video by using AI model to identify known or new category;
Generating in real time personal/customized AI model for new category by learning subject by third party AI large language acting as an expert for generating new AI model for new category trained by data of different types of videos and use case, for different subjects and video structure;
Generating in real time personal/customized video by applying the generated AI model of the new category using the user original prompt.
According to some embodiments of the present invention the personal/customized AI model is further trained based on data for different video styles including at least one of: problem, solution, advantages, advertising, humor, educational.
According to some embodiments of the present invention the method further comprising the steps of creating story board images or short video or text displayed on the screen, the user can review edit or approve the storyboard before generating the video.
According to some embodiments of the present invention the method further comprising the steps of creating wherein the AI model is further trained to adapt its content generation to match the style and personality that best suits the target audience.
According to some embodiments of the present invention the creation the AI model learning/training is further provided with a deep understanding of the rules and conventions governing content creation within the specific field by training the AI model of different fields which includes different industry standards, ethical guidelines, or legal constraints.
According to some embodiments of the present invention the method further comprising the steps of: data collection and preprocessing including
   Gather a vast collection of videos across various categories.
   Categorize videos by themes/style including: problem solving advertising, humor, education.
   Use a large language model to transcribe video content and store metadata.
   Extract features related to the structure of videos.
According to some embodiments of the present invention the creation the generated AI models for new category are saved, enabling to retrieve upon identifying saved category in user text for generating video.

The present invention provides a system for generating customized AI model for generating video, said system implemented by one or more processors operatively coupled to a non-transitory computer readable storage device, on which comprised the modules:
User interface module configured to Identifying from user text of new category for generating video by analyzing context, comparing to known categories of video by using AI model to identify known or new category;
AI director bot module configured for Generating in real time personal/customized AI model for new category by learning subject by third party AI large language acting as an expert for generating new AI model for new category trained by data of different types of video and use case, for different subjects and video structure and generating in real time personal/customized video by applying the generated AI model of the new category using the user original prompt.

According to some embodiments of the present invention the personal/customized AI model is further trained based on data for different video styles including at least one of: problem, solution, advantages, advertising, humor, educational.

According to some embodiments of the present invention the creation the AI director bot module is further configured to create story board images or short video or text displayed on the screen, the user can review edit or approve the storyboard before generating the video.

According to some embodiments of the present invention the creation the AI model is further trained to adapt its content generation to match the style and personality that best suits the target audience.

According to some embodiments of the present invention the creation the AI model learning/training is further provided with a deep understanding of the rules and conventions governing content creation within the specific field by training the AI model of different fields which includes different industry standards, ethical guidelines, or legal constraints.

According to some embodiments of the present invention the creation the AI director bot module is further configured to apply: data collection and preprocessing including
Gather a vast collection of videos across various categories.
Categorize videos by themes/style including problem solving advertising, humor, education.
Use a large language model to transcribe video content and store metadata.
Extract features related to the structure of videos.
According to some embodiments of the present invention the creation the generated AI models for new category are saved, enabling to retrieve upon identifying saved category in user text for generating video.

The present invention provides a method for generating customized AI model for generating video, implemented by one or more processors operatively coupled to a non-transitory computer readable storage device, on which are stored modules of instruction code that when executed cause the one or more processors to perform said method comprising the steps of:
Identifying from user text of new category for generating video by analyzing context, comparing to known categories of video by using AI model to identify known or new category;
Generating in real time personal/customized AI model for new category by learning subject by research video in this category trained by data of different types of videos and use case, for different subjects and video structure;
Generating in real time personal/customized video by applying the generated AI model of the new category using the user original prompt.

### BRIEF DESCRIPTION OF THE SCHEMATICS

The present invention will be more readily understood from the detailed description of embodiments thereof made in conjunction with the accompanying drawings of which:

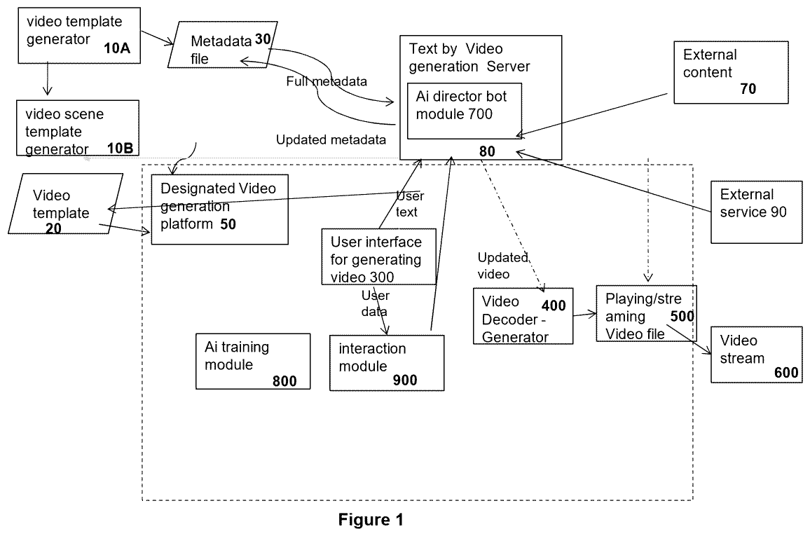

FIG. 1 is a block diagram, depicting the components and the environment of the video generation platform, according to some embodiments of the invention.

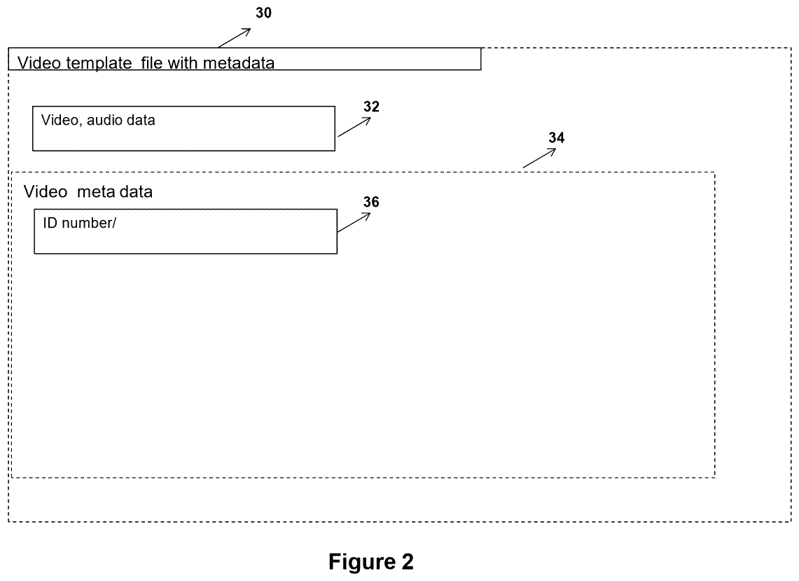

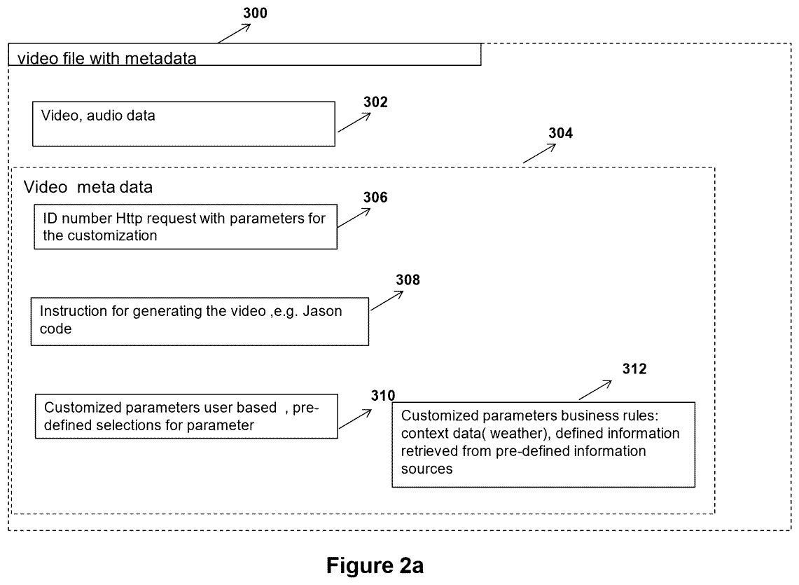

FIG. 2 is a block diagram depicting the video file format information structure, according to one embodiment of the invention.

FIG. 2A is a block diagram depicting the video file format information structure, according to one embodiment of the invention.

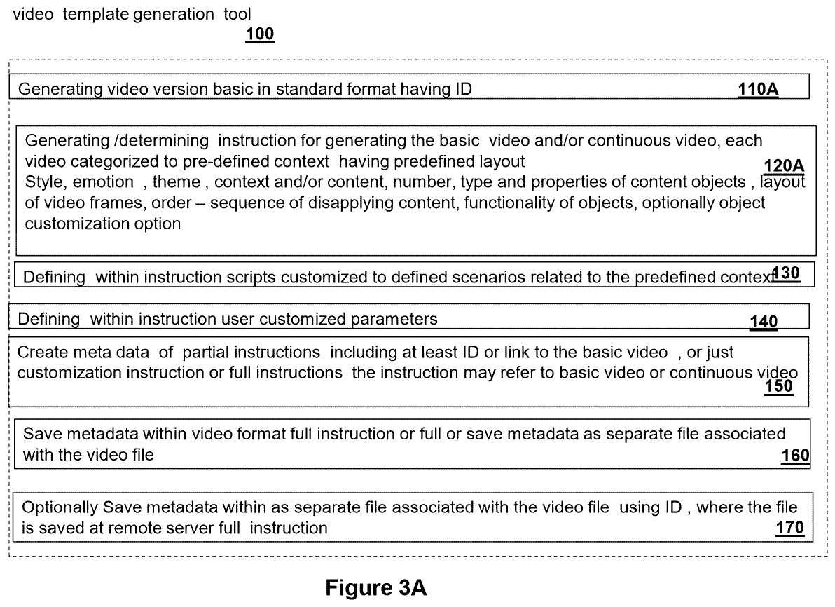

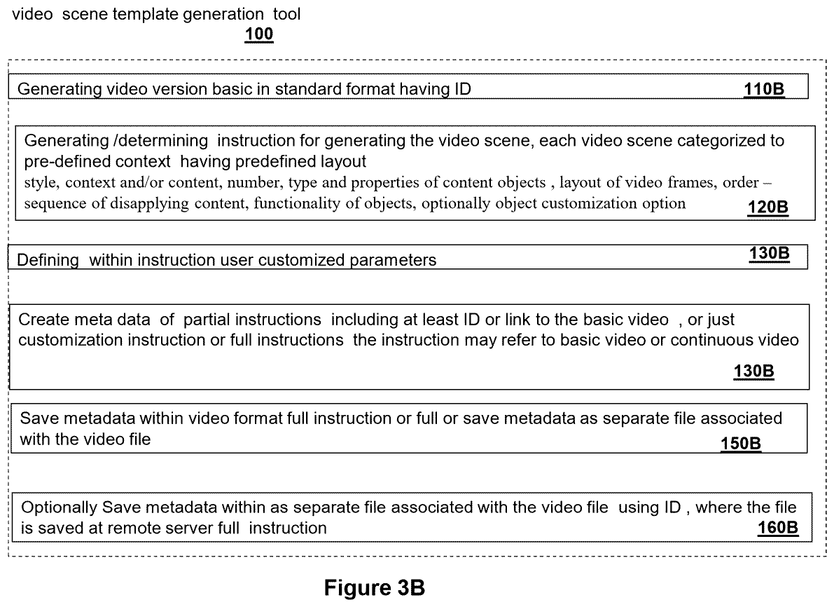

FIG. 3A is a flowchart depicting the video template generation module, according to some embodiments of the invention.

FIG. 3B is a flowchart depicting the video scene template generation module, according to some embodiments of the invention.

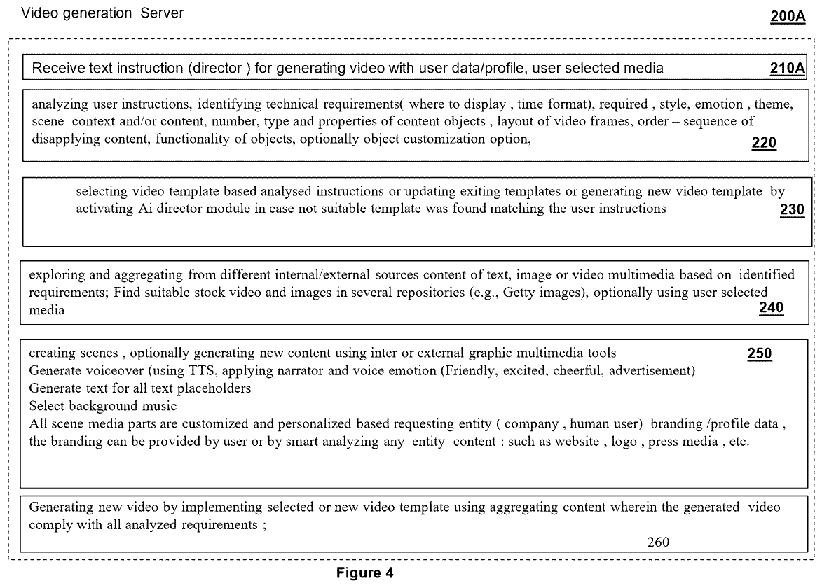

FIG. 4 is a flowchart depicting video generating by text server module according to some embodiments of the invention.

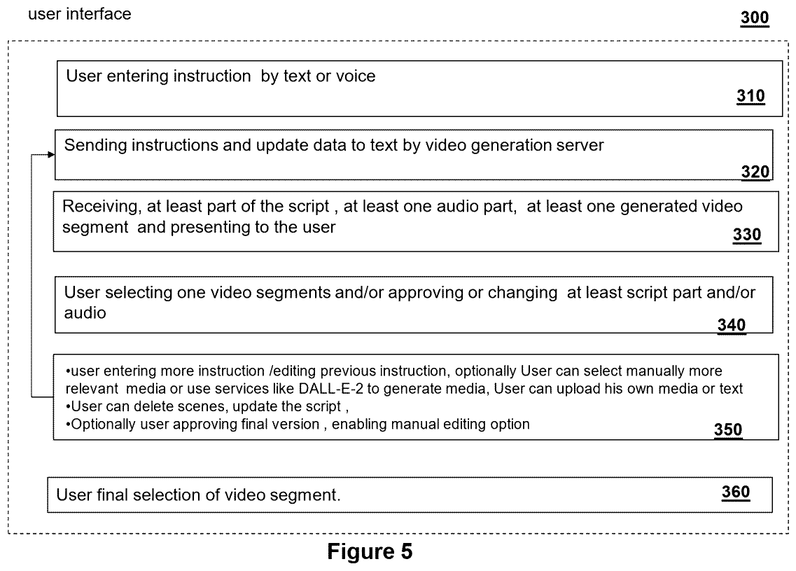

FIG. 5 presents a flowchart of the video user interface, according to some embodiments of the invention.

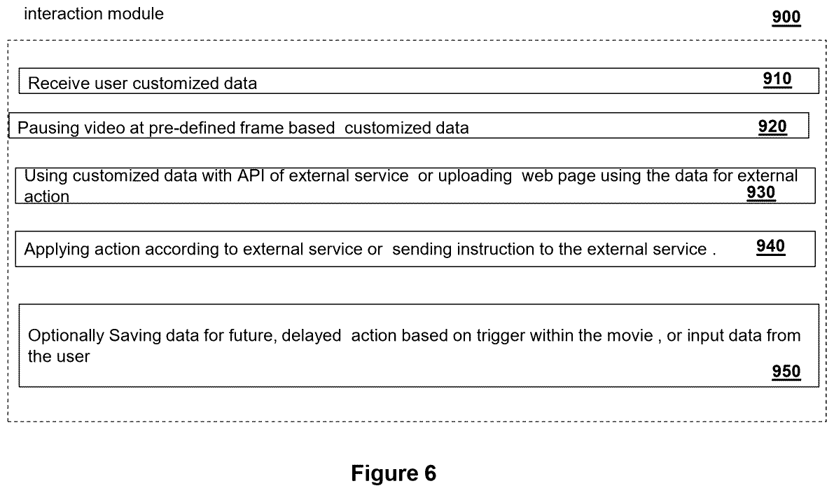

FIG. 6 presents a flowchart of the video interaction module, according to some embodiments of the invention.

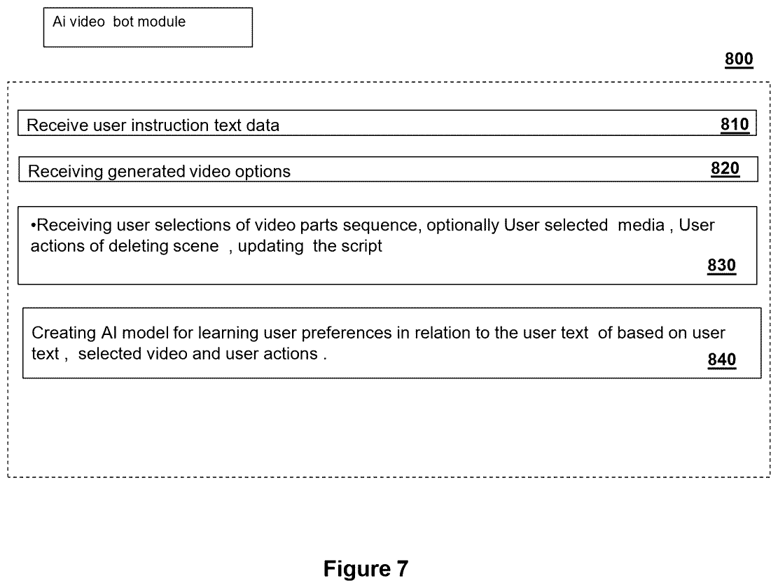

FIG. 7 presents a flowchart of the Ai video module, according to some embodiments of the invention.

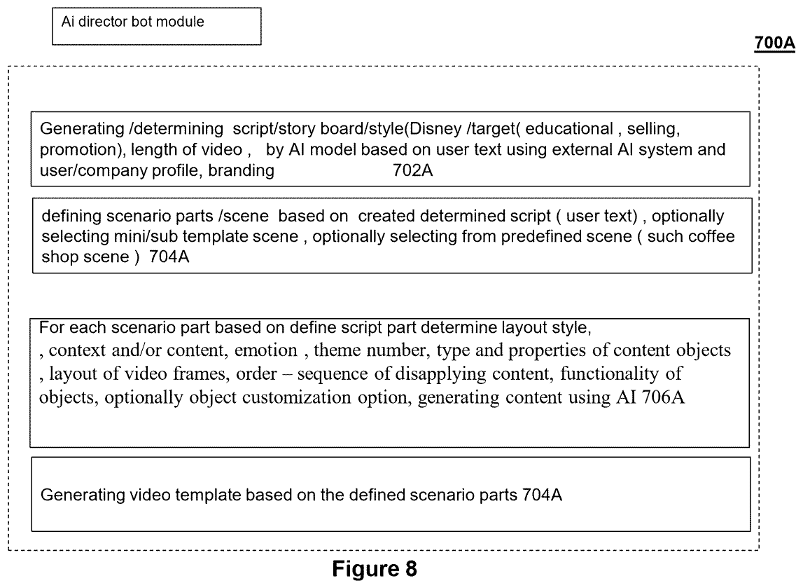

FIG. 8 presents a flowchart of the Ai director bot module, according to some embodiments of the invention.

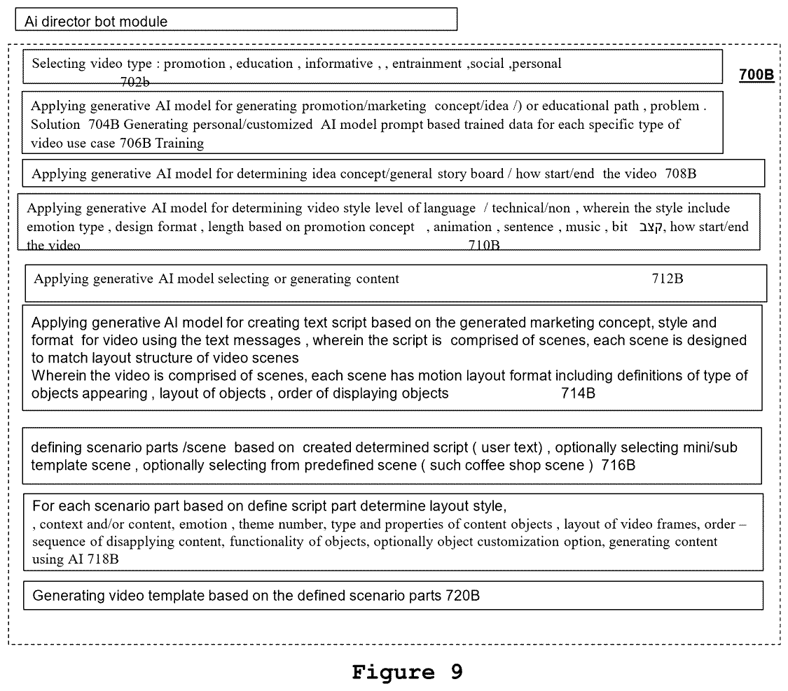

FIG. 9 presents a flowchart of the Ai director bot module, according to some embodiments of the invention.

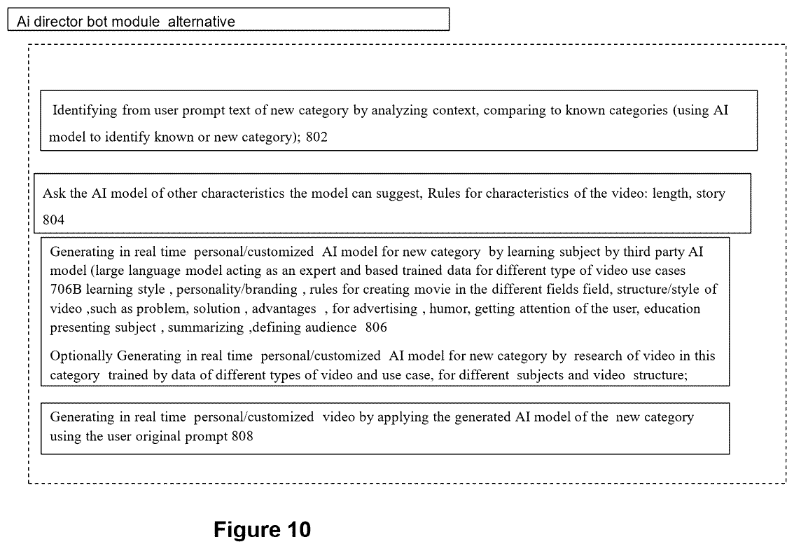

FIG. 10 presents a continued flowchart of the Ai director bot module, according to some embodiments of the invention.

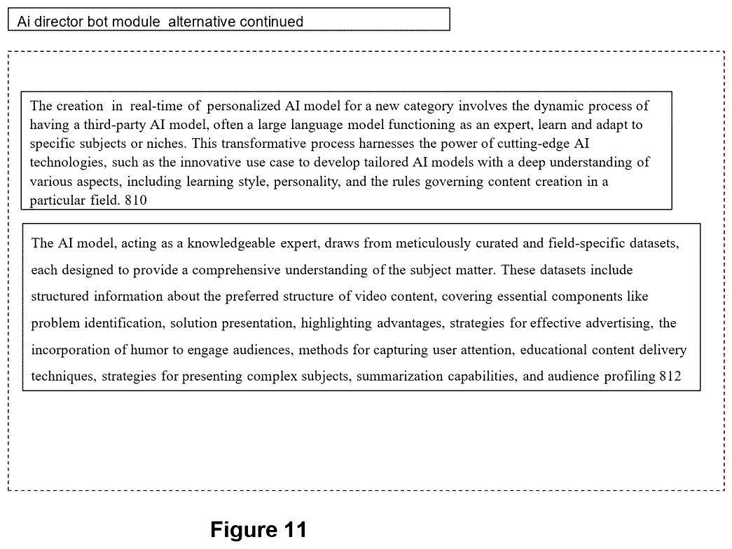

FIG. 11 presents a continued flowchart of the Ai director bot alternative module, according to some embodiments of the invention.

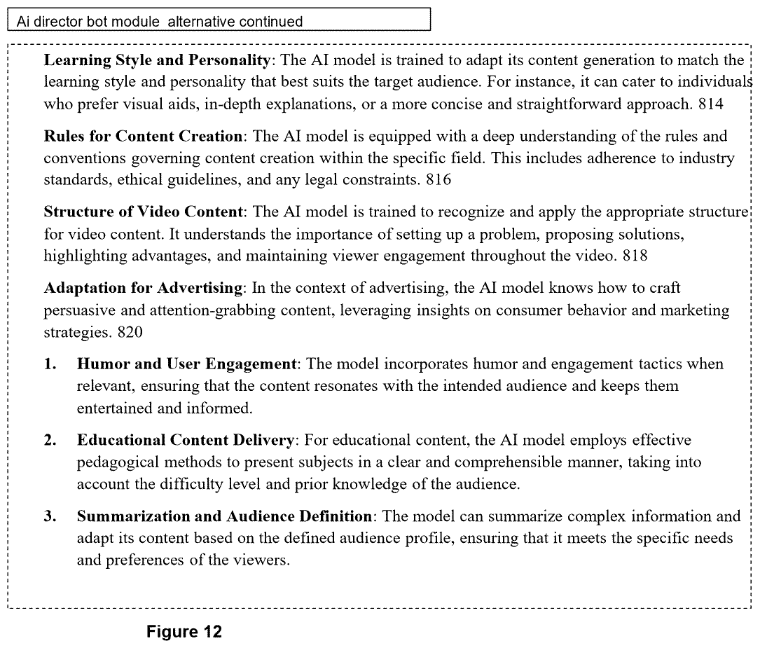

FIG. 12 presents a continued flowchart of the Ai director bot alternative module continuation, according to some embodiments of the invention.

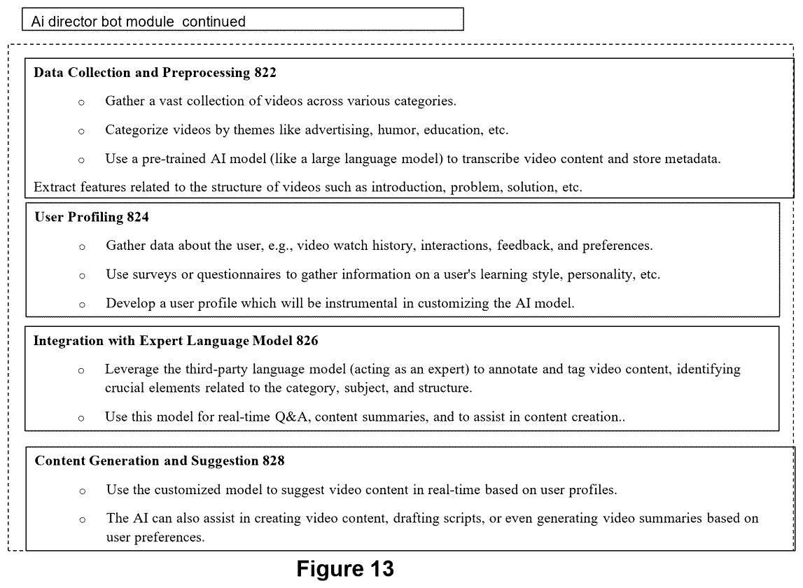

FIG. 13 presents a continued flowchart of the Ai director bot alternative module continuation, according to some embodiments of the invention.

### DETAILED DESCRIPTION OF THE VARIOUS MODULES

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

FIG. 1 is a block diagram, depicting the components and the environment of the video generation platform 50, according to some embodiments of the invention. The Designated Video generation platform 50 is comprised of: a user interface configured to receive user to entered text and select between optional generated videos 300, interface module 900 configured for customizing the video by the user and text and video generation server 80 configured to receive users' text, selection and customized data for generating relevant video parts based on pre-defined video templates or by using AI director module 700. The platform further comprises Video Decoder—Generator, Playing/streaming Video file, 600, and Ai training module 800 A.

FIG. 2 is a block diagram depicting the video file format information structure, according to one embodiment of the invention.

According to this embodiment, the video file format of digital media container 30 is comprised of video or audio data 32 and meta data 34. The metadata comprises only video ID or a link to the video 36, where metadata file is associated with the video ID or link.

FIG. 2A is a block diagram depicting the video file format information structure, according to one embodiment of the invention.

The video file format of digital media container 300 is comprised of video or audio data 302 and meta data 304. The meta data comprises at least video ID or a link 306 and/or optionally partial or full video generation instructions 308 and/or customized parameters 310. Optionally including Link to originating Video editor full project data 312.

FIG. 3A is a flowchart depicting the video template generation module, according to some embodiments of the invention.

The video template generation module applies at least one of the followings steps

Generating video version basic in standard format having ID, 110 Generating/determining instruction for generating the basic video and/or continuous video, each video categorized to pre-defined context having predefined layout.
style, emotion context and/or content, number, type and properties of content objects, layout of video frames, order—sequence of disapplying content, functionality of objects, optionally object customization option; 120
Defining within instruction scripts customized to defined scenarios related to the predefined context.
Defining within instruction user customized parameters 130;
Create meta data of partial instructions including at least ID or link to the basic video, or just customization instruction or full instructions the instruction may refer to basic video or continuous video 140;
Save metadata within video format full instruction or full or save metadata as separate file associated with the video file 150;
Optionally Save metadata within as separate file associated with the video file using ID, where the file is saved at remote server full instruction 160.

FIG. 3B is a flowchart depicting the video scene template generation module, according to some embodiments of the invention.

The video template generation module applies at least one of the followings steps:
Generating video version basic in standard format having ID, 110
   Generating/determining instruction for generating the video scene, each video scene categorized to pre-defined context having predefined layout.
   style, emotion, context and/or content, number, type and properties of content objects, layout of video frames, order—sequence of disapplying content, functionality of objects, optionally object customization option, 120;
Defining within instruction user customized parameters 130;
Create meta data of partial instructions including at least ID or link to the basic video, or just customization instruction or full instructions the instruction may refer to basic video or continuous video 140;
Save metadata within video format full instruction or full or save metadata as separate file associated with the video file 150;
Optionally Save metadata within as separate file associated with the video file using ID, where the file is saved at remote server full instruction 160.

FIG. 4 is a flowchart depicting video generating by text server module according to some embodiments of the invention. The text server module applies at least one of the following steps:
Receive text instruction for generating video with user data/profile 210;
analyzing user instructions, identifying technical requirements (where to display, time format), required, style, emotion, theme, context and/or content, number, type and properties of content objects, layout of video frames, order—sequence of disapplying content, functionality of objects, optionally object customization option 220;
selecting video template based analyzed instructions or updating exiting templates or generating new video template 230;
exploring and aggregating from different internal/external sources content of text, image or video multimedia based on identified requirements 240;
creating scenes, optionally generating new content using inter or external graphic multimedia tools.
Generate voiceover (using TTS, applying narrator and voice emotion (Friendly, excited, cheerful, advertisement)
Generate text for all text placeholders.
Select background music.

All scene media parts are customized and personalized based requesting entity (company, human user) branding/profile data, the branding can be provided by user or by smart analyzing any entity content: such as website, logo, press media, etc. 250.

Generating new video by implementing selected or new video template using aggregating content wherein the generated video complies with all analyzed requirements 260.

FIG. 5 presents a flowchart of the video user interface, according to some embodiments of the invention.

The user interface module applies at least one of the following steps.
User entering instruction by text or voice 310;
Sending instructions to text by video generation server 320;
Receiving, at least part of the script, at least one audio part, at least one generated video segment and presenting to the user 330;
User selecting one video segment 340.
user entering more instruction/editing previous instruction, optionally User can select manually more relevant media or use services like DALL-E-2 to generate media, User can upload his own media or text User can delete scenes, update the script, Optionally the user approving final version, enabling manual editing option 350;
User final selection of video segment 360.

FIG. 6 presents a flowchart of the video interaction module, according to some embodiments of the invention.

The user video interaction module applies at least one of the following steps:
Receive user customized data 910.
Pausing video at pre-defined frame based customized data 920;
Using customized data with API of external service or uploading web page using the data for external action 930;
Applying action according to external service or sending instruction to the external service 940.
Optionally Saving data for future, delayed action based on trigger within

the movie, or input data from the user 950.

FIG. 7 presents a flowchart of the Ai video bot module, according to some embodiments of the invention.

The Ai video bot module apply at least one of the followings steps:
Receive user text data 810;
Receiving generated video options 820;
Receiving user selections of video parts sequence, optionally User selected media, User actions of deleting scene, updating the script 830;
Creating AI model for learning user preferences in relation to the user text of based on user text, selected video and user actions 840.

FIG. 8 presents a flowchart of the Ai director bot module, according to some embodiments of the invention.

The Ai director video bot module apply at least one of the followings steps:
Generating/determining script/story board/style (Disney/target (educational, selling, promotion), length of video, by AI model based on user text using external AI system 702.
defining scenario parts/scene based on created determined script (user text), selecting mini/sub template scene, optionally selecting from predefined scene (such coffee shop scene) 704;

For each scenario part based on define script part determine layout style,
context and/or content, number, type and properties of content objects, layout of video frames, order—sequence of disapplying content, functionality of objects, optionally object customization option, generating content using AI 704.

FIG. 9 presents a flowchart of the Ai director bot module, according to some embodiments of the invention.
The Ai director video bot module apply at least one of the followings steps Selecting video type: promotion, education, informative, entrainment, social, personal
Applying generative AI model for generating promotion/marketing concept/idea/) or educational path, problem. Solution 704B
Generating personal AI model prompt based trained data for each specific type of video use case 706B
Applying generative AI model for determining idea concept/general story board 708B
Applying generative AI model for determining video style, wherein the style include emotion type, design format, length based on promotion concept, animation, sentence 710B
Applying generative AI model selecting or generating content 712B
Applying generative AI model for creating text script based on the generated marketing concept, style and format for video using the text messages, wherein the script is comprised of scenes, each scene is designed to match layout structure of video scenes
Wherein the video is comprised of scenes, each scene has motion layout format including definitions of type of objects appearing, layout of objects, order of displaying objects 714B

### Creating a Text Script Using a Generative AI Model

The AI model is adept at crafting text scripts tailored for videos. This capability is particularly beneficial for videos that aim to convey specific marketing concepts. The process involves:

### 1. Concept Integration:

The AI model takes into account the previously generated marketing concept, ensuring that the script aligns with the intended promotional message.

### 2. Style and Format Consideration:

The model also considers the chosen style and format for the video.

This ensures that the script not only conveys the right message but does so in a manner that complements the overall aesthetic and feel of the video.

### 3. Utilization of Text Messages:

The script can incorporate text messages, allowing for a more dynamic and interactive video experience. This can be especially useful for videos targeting younger audiences familiar with messaging platforms.

### 4. Scene Composition:

The script is structured into various scenes. Each scene is meticulously designed to align with the layout structure typical of video scenes, ensuring a seamless viewing experience.
Motion Layout Format:
Every scene in the video has a distinct motion layout format. This format provides detailed specifications, such as:
   The types of objects that will appear in the scene.
   The layout or arrangement of these objects.
   The sequence in which these objects will be displayed, ensuring a logical and engaging flow.

This elaboration provides a comprehensive overview of how the generative AI model aids in script creation, ensuring that the resulting video is both engaging and effective in conveying its intended message.
defining scenario parts/scene based on created determined script (user text), optionally selecting mini/sub template scene, optionally selecting from predefined scene (such coffee shop scene) 716B
For each scenario part based on define script part determine layout style, context and/or content, emotion, theme number, type and properties of content objects, layout of video frames, order-sequence of disapplying content, functionality of objects, optionally object customization option, generating content using AI 718B
Applying generative AI model for generating promotion/marketing concept/idea/) or educational path, problem. Solution 704B
Generating personal/customized AI model prompt based trained data for each specific type of video use case 706B

### FIG. 9: Flowchart of the AI Director Bot Module

According to certain embodiments of the invention, FIG. 9 illustrates the workflow of the AI Director Bot Module. This module encompasses several steps to automate video creation and editing:
1. Video Type Selection (Step 702B)
   The AI Director Bot Module begins by selecting a video type. The available options include:
      Promotion
      Education
      Informative
      Entertainment
      Social
      Personal
2. Generative AI Model Application (Step 704B)
   The module applies a generative AI model to produce concepts or ideas tailored for specific video types. For instance:
      Generating a promotional or marketing concept
      Outlining an educational path, identifying problems, and suggesting solutions
3. Personal AI Model Generation (Step 706B)
   A unique AI model prompt is generated based on trained data for each specific video use case.
4. Storyboard Determination (Step 708B)
   The generative AI model is employed to determine the overarching idea, concept, or general storyboard for the video.
5. Video Style Determination (Step 710B)
   The AI model determines the video's style, considering various factors such as:
      Emotion type
      Design format
      Video length (which might be influenced by the promotional concept)
      Animation preferences
      Sentence structures
6. Content Selection or Generation (Step 712B)
   The AI model selects or generates content suitable for the video.
7. Script Creation (Step 714B)
   The generative AI model crafts a text script based on the generated marketing concept, style, and format. This script:
      Consists of multiple scenes
      Ensures each scene aligns with the layout structure of video scenes
      Details the motion layout format, including the type of objects appearing, their layout, and the sequence in which they are displayed
8. Scenario Definition (Step 716B)
   The script is used to define individual scenario parts or scenes.
   Options are provided to select mini or sub-template scenes.
   Users can also choose from predefined scenes, such as a coffee shop setting.
9. Layout and Content Determination for Each Scenario (Step 718B)
   For each defined scenario part, the module determines:
      Layout style
      Context and content
      Emotion conveyed
      Theme number
      Type and properties of content objects
      Frame layout of the video
      Sequence of content display
      Functionality of objects
   Additionally, there's an option for object customization, and content can be generated using AI.

FIG. 10 presents a continued flowchart of the Ai director bot alternative module, according to some embodiments of the invention.

The flowchart of the Ai director bot module further process one of the following steps:
Identifying from user text of new category by analyzing context, comparing to known categories (using AI model to identify known or new category); 802
Ask the AI model of other characteristics the model can suggest, Rules for characteristics of the video: length, story 804;
Generating in real time personal/customized AI model for new category by learning subject by third party AI model large language model acting as an expert for generating new AI model for new category and based on trained data for each specific type of video use case learning style, personality, rules for creating movie in the specific field, structure of video, such as problem, solution, advantages, for advertising, humor, getting attention of the user, education presenting subject, summarizing, defining audience 806;
Optionally Generating in real time personal/customized AI model for new category by research of video in this category trained by data of different types of videos and use case, for different subjects and video structure;
Generating in real time personal/customized video by applying the generated AI model of the new category using the user original prompt; 808
The generated AI models for new category are saved enabling to retrieve upon identifying saved category in user text for generating video.
This processing of AI video generation replaces the traditional video generation using Ai agency: replacing human agency, generating video brief by the ai instead of agency
Optionally Apply designated AI model for Creating Story board images or short video, text displayed on the screen, the user can review edit or approval the storyboard before generating the video.
According to some embodiments the generated AI models for new category are saved, enabling to retrieve upon identifying saved category in user text for generating video.
   The flowchart of the Ai director bot module further process one of the following steps:

FIG. 11 presents a continued flowchart of the Ai director bot alternative module, according to some embodiments of the invention.
The creation of a real-time, personalized AI model for a new category involves the dynamic process of having a third-party AI model, often a large language model functioning as an expert, learn and adapt to specific subjects or niches. This transformative process harnesses the power of cutting-edge AI technologies, such as the innovative use case to develop tailored AI models with a deep understanding of various aspects, including learning style, personality, and the rules governing content creation in a particular field. 810
To clarify, the concept of learning' refers to a highly specialized approach where AI models are trained on domain-specific data, which encapsulates subject matter, stylistic nuances, and industry-specific knowledge. This training process is integral to crafting AI models that can adeptly create content in their designated areas of expertise. 812
The AI model, acting as a knowledgeable expert, draws from meticulously curated and field-specific datasets, each designed to provide a comprehensive understanding of the subject matter. These datasets include structured information about the preferred structure of video content, covering essential components like problem identification, solution presentation, highlighting advantages, strategies for effective advertising, the incorporation of humor to engage audiences, methods for capturing user attention, educational content delivery techniques, strategies for presenting complex subjects, summarization capabilities, and audience profiling.

FIG. 12 presents a continued flowchart of the AI model training 800, according to some embodiments of the invention.

Key Aspects of this Intricate Process:
1. Learning Style and Personality (defining target audience): The AI model is trained to adapt its content generation to match the learning style and personality that best suits the target audience. For instance, it can cater to individuals who prefer visual aids, in-depth explanations, or a more concise and straightforward approach. 814
2. Rules for Content Creation: The AI model is equipped with a deep understanding of the rules and conventions governing content creation within the specific field. This includes adherence to industry standards, ethical guidelines, and any legal constraints. 816
3. Structure of Video Content: The AI model is trained to recognize and apply the appropriate structure for video content. It understands the importance of setting up a problem, proposing solutions, highlighting advantages, and maintaining viewer engagement throughout the video. 818
4. Adaptation for Advertising: In the context of advertising, the AI model knows how to craft persuasive and attention-grabbing content, leveraging insights on consumer behavior and marketing strategies. 820
5. Humor and User Engagement: The model incorporates humor and engagement tactics when relevant, ensuring that the content resonates with the intended audience and keeps them entertained and informed. 822
6. Educational Content Delivery: For educational content, the AI model employs effective pedagogical methods to present subjects in a clear and comprehensible manner, taking into account the difficulty level and prior knowledge of the audience. 824
7. Summarization and Audience Definition: The model can summarize complex information and adapt its content based on the defined audience profile, ensuring that it meets the specific needs and preferences of the viewers. 826
   In essence, the real-time generation of personalized AI models for new categories is a groundbreaking approach that empowers businesses and content creators to harness the full potential of AI in delivering tailored and compelling content experiences, while maintaining a deep understanding of the intricacies of their respective domains.”

FIG. 13 presents a continued flowchart of the AI model training 800 module continuation, according to some embodiments of the invention.

Generating a real-time personalized AI model for a new category by leveraging a third-party AI model, especially for video content, is an ambitious and exciting undertaking. Step for implementation of the AI training using the AI model training 800:
2. Data Collection and Preprocessing 822;
   Gather a vast collection of videos across various categories.
   Categorize videos by themes like advertising, humor, education, etc.
   Use a pre-trained AI model (like a large language model) to transcribe video content and store metadata.
   Extract features related to the structure of videos such as introduction, problem, solution, etc.
3. User Profiling 824 improvement of video
   Gather data about the user, e.g., video watch history, interactions, feedback, and preferences.
   Develop a user profile which will be instrumental in customizing the AI model.
4. Integration with Expert Language Model 826
   Leverage the third-party language model (acting as an expert) to annotate and tag video content, identifying crucial elements related to the category, subject, and structure.
   Use this model for real-time Q&A, content summaries, and to assist in content creation.
5. Model Training and Customization 828
   Using a base model, fine-tune with user-specific data to create a customized AI model.
   Continuously update the model based on user feedback and interactions.
   Utilize transfer learning to benefit from the pre-trained models and adapt to specific user needs.
6. Content Generation and Suggestion 830
   Use the customized model to suggest video content in real-time based on user profiles.
   The AI can also assist in creating video content, drafting scripts, or even generating video summaries based on user preferences.
7. Feedback Loop 832
   Implement a feedback mechanism where users can provide ratings, comments, and suggestions on the AI's recommendations.
   Use this feedback to further refine and enhance the model's accuracy and personalization.
8. Audience Definition
   Use the AI to analyze video content and define potential audience segments.
   Segment users based on preferences, demographics, viewing habits, etc., and cater content recommendations accordingly.
      By following this blueprint, you can create a dynamic, real-time AI model that offers a personalized experience for users, adapting to their preferences and needs

The system of the present invention may include, according to certain embodiments of the invention, machine readable memory containing or otherwise storing a program of instructions which, when executed by the machine, implements some or all of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program such as but not limited to a general-purpose computer which may optionally be configured or activated in accordance with the teachings of the present invention. Any of the teachings incorporated herein may wherever suitably operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g., digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer-or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for generating customized AI model for generating video, implemented by one or more processors operatively coupled to a non-transitory computer readable storage device, on which are stored modules of instruction code that when executed cause the one or more processors to perform said method comprising the steps of:
identifying from user text of new category for generating video by analyzing context, comparing to known categories of video by using AI model to identify known or new category;
generating in real time personal/customized AI model for new category by learning subject by third party AI large language acting as an expert for generating new AI model for new category trained by data of different types of videos and use case, for different subjects and video structure;
generating in real time personal/customized video by applying the generated AI model of the new category using the user original prompt.

2. The method of claim 1 wherein the personal/customized AI model is further trained based on data for different video styles including at least one of: problem, solution, advantages, advertising, humor, educational.

3. The method of claim 1 further creating story board images or short video or text displayed on the screen, the user can review edit or approve the storyboard before generating the video.

4. The method of claim 1 wherein the AI model is further trained to adapt its content generation to match the style and personality that best suits the target audience.

5. The method of claim 1 wherein the AI model learning/training is further provided with a deep understanding of the rules and conventions governing content creation within the specific field by training the AI model of different fields which includes different industry standards, ethical guidelines, or legal constraints.

6. The method of claim 1 further comprising the step of: data collection and preprocessing including
Gather a vast collection of videos across various categories.
Categorize videos by themes/style including: problem solving advertising, humor, education.
Use a large language model to transcribe video content and store metadata.
Extract features related to the structure of videos.

7. The method of claim 1 wherein the generated AI models for new category are saved, enabling to retrieve upon identifying saved category in user text for generating video.

8. A system for generating customized AI model for generating video, said system implemented by one or more processors operatively coupled to a non-transitory computer readable storage device, on which comprised the modules:
user interface module configured to Identifying from user text of new category for generating video by analyzing context, comparing to known categories of video by using AI model to identify known or new category;
AI director bot module configured for Generating in real time personal/customized AI model for new category by learning subject by third party AI large language acting as an expert for generating new AI model for new category trained by data of different types of video and use case, for different subjects and video structure and generating in real time personal/customized video by applying the generated AI model of the new category using the user original prompt.

9. The system of claim 8 wherein the personal/customized AI model is further trained based on data for different video styles including at least one of: problem, solution, advantages, advertising, humor, educational.

10. The system of claim 8 wherein the AI director bot module is further configured to create story board images or short video or text displayed on the screen, the user can review edit or approve the storyboard before generating the video.

11. The system of claim 8 wherein the AI model is further trained to adapt its content generation to match the style and personality that best suits the target audience.

12. The method of claim 8 wherein the AI model learning/training is further provided with a deep understanding of the rules and conventions governing content creation within the specific field by training the AI model of different fields which includes different industry standards, ethical guidelines, or legal constraints.

13. The system of claim 8 wherein the AI director bot module is further configured to apply: data collection and preprocessing including
Gather a vast collection of videos across various categories.
Categorize videos by themes/style including problem solving advertising, humor, education.
Use a large language model to transcribe video content and store metadata.
Extract features related to the structure of videos.

14. The system of claim 8 wherein the generated AI models for new category are saved, enabling to retrieve upon identifying saved category in user text for generating video.

15. A method for generating customized AI model for generating video, implemented by one or more processors operatively coupled to a non-transitory computer readable storage device, on which are stored modules of instruction code that when executed cause the one or more processors to perform said method comprising the steps of:
Identifying from user text of new category for generating video by analyzing context, comparing to known categories of video by using AI model to identify known or new category;
Generating in real time personal/customized AI model for new category by learning subject by research video in this category trained by data of different types of videos and use case, for different subjects and video structure;
Generating in real time personal/customized video by applying the generated AI model of the new category using the user original prompt.
